(19) United States
(12) Patent Application Publication
(10) Pub. No.: US 2010/0319674 A1
(43) Pub. Date: Dec. 23, 2010

(54) OUTDOOR GRILL ASSEMBLY

(76) Inventor: DOUG SCHNEIDEWEND, Greenville, WI (US)

Correspondence Address: LAW OFFICE OF JERRY D. HAYNES , P.A, P.O. Box 350392, Fort Lauderdale, FL, 33335, US

(21) Appl. No.: 12/821,645

(22) Filed: Jun. 23, 2010

Related U.S. Application Data
(60) Provisional application No. 61/219,542, filed on Jun. 23, 2009.

(51) Int. Cl. A47J 37/07

(52) U.S. Cl. 126/30

(57) ABSTRACT

The present invention relates to an outdoor grilling assembly for open firing cooking comprising: a vertical stake assembly, where said vertical stake assembly includes a rotating outer sleeve, a tension collar, a tension bolt, and an anchor pipe; an arm extension attached to the top end of the rotating outer sleeve via a channel iron; a threaded screw extending through an opening of the channel iron; a handle, where said handle is attached to the top end of the threaded screw; and a grill, said grill includes a channel/angle iron where said channel/angle iron provides a means to connect the grill to the distal end of the threaded screw and arm extension assembly. The rotating outer sleeve extends over the anchor pipe, where the tension collar and tension bolt provide a means to adjust the outer sleeve.

### CROSS REFERENCE TO OTHER APPLICATIONS

This application claims priority to U.S. Provisional Application Ser. No. 61/219,542 filed on Jun. 23, 2009.

### BACKGROUND OF THE INVENTION

1. Field of Invention

The present invention relates to an outdoor grilling assembly for grilling foods over an open fire.

2. Description of Related Art

Outdoor campfire cooking usually involves a portable cooking grill assembly that provides a means to hold food over an open campfire. The portable grilling assembly usually comprises a grill, stake and attachment means to attach the grill to the stake during the cooking process. The assemblies of the prior art may include vertical adjustment means that involves either a screw assembly or clamping mechanism to adjust the vertical height of the grill during the cooking process. The vertical adjustment essentially helps to regulate cooking intensity and heat applied to the food. The vertical adjustment means may also include a locking mechanism where the grill is locked at its desired height and therefore may limit the ability to adjust the height after the cooking process has commenced.

The grilling assemblies of prior art include the basic components as described above, a vertical stake, a grill and an attachment means, usually an arm that attaches the grill to the stake. The vertical adjustment mechanisms have seen various innovations developed over a period of time. The vertical adjustment support and other mechanisms of grilling assemblies however have not been optimized and therefore a need for a more efficient and easy mechanism to adjust and maneuver the grill over the open fire is therefore needed. The position control mechanisms that control the position of the grill over the campfire are critical in controlling cooking speed and the heat intensity applied to the food on the grill.

### SUMMARY OF THE INVENTION

The present invention relates to an outdoor grilling assembly for open firing cooking comprising: a vertical stake assembly, where said vertical stake assembly includes a rotating outer sleeve, a tension collar, a tension bolt, and an anchor pipe; an arm extension attached to the top end of the rotating outer sleeve via a channel iron; a threaded screw extending through an opening of the channel iron; a handle, where said handle is attached to the top end of the threaded screw; and a grill, said grill includes a channel/angle iron where said channel/angle iron provides a means to connect the grill to the distal end of the threaded screw and arm extension assembly. The rotating outer sleeve extends over the anchor pipe, where the tension collar and tension bolt provide a means to adjust the outer sleeve. The anchor pipe may be driven into the ground to provide a stable means to support the outdoor grilling assembly.

### BRIEF DESCRIPTION OF DRAWINGS

FIG. 1 depicts an outdoor cooking assembly according to the present invention

### DETAILED DESCRIPTION

The present invention relates to an outdoor cooking assembly that includes a vertical adjustable stake and an adjustable arm attachment means for the grill. The present invention provides a dynamic and highly adjustable means to position the placement of the grill over the open fire. The stake utilized with the present invention is rotatably adjustable and the vertical height of the stake and grill may be adjusted as needed. The position of the grill during the cooking process may be adjusted by using a handle that extends from the attachment means and therefore provides a more dynamic adjusting mechanism for the outdoor grilling assembly according to the present invention.

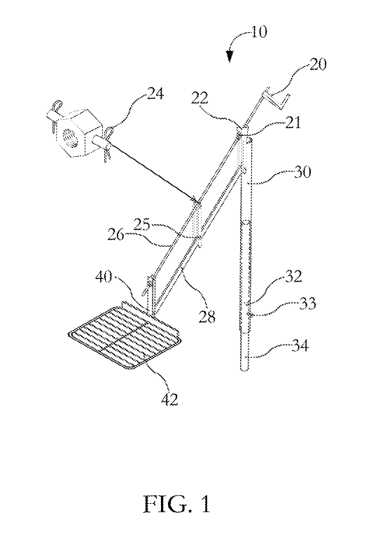

An outdoor grilling assembly 10 is depicted in FIG. 1. The outdoor grilling assembly 10 includes a vertical stake assembly that includes a rotating outer sleeve 30, a tension collar 32, a tension bolt, and an anchor pipe 34. The rotating outer sleeve 30 extends over the anchor pipe 34 and may be adjusted by using the tension collar 32 and tension bolt 33. The anchor pipe 34 is driven into the ground to provide a stable means to support the outdoor grilling assembly 10. The tensioning collar 32 may be positioned vertically along the anchor pipe 34 and tensions the rotating outer sleeve 30 into a suitable vertical position along the anchor pipe 34. The outer sleeve 30 may also be rotated to provide a horizontal adjustment means for the grilling assembly 10. The tensioning collar 32 may be held into place with tensioning bolt 33 and provides a means to support the stake assembly.

Attached to the top end of the rotating outer sleeve 30 are an arm extension 28 and a channel iron 22. The channel iron 22 attaches to the top end of the rotating outer sleeve 30 to support the arm extension 28 that provides a means to support the cooking grill 42. On the top end of the channel iron 22, a threaded screw 26 is provided that extends through the channel iron 22 with a handle 20 attached to the top end thereof and a channel/angle iron connection 40 attaches to the opposite end of the threaded screw 26. A channel iron 25 is provided near the midpoint of the arm extension 28 which joins the arm extension 28 to the threaded screw 26.

Atop the channel iron 25 is a clip pin nut 24 that secures the connection of the channel iron 25 to the threaded screw 26. Threads are provided within the clip pin nut 24 to allow the free movement of the threaded screw 26. A user may maneuver the threaded screw 26 by rotating the handle 20 in either a clockwise or counter-clockwise direction in order to effectively maneuver the angle and height of the cooking grill 42.

The channel angle iron connection 40 secures the grill and rear angle iron to the channel iron that attaches to the distal end of the arm extension 28 and threaded screw 26. An opening is provided at the top end of the channel/angle iron connector 40 for the insertion of the threaded screw 26. The threaded screw 26 maneuvers through this opening and therefore may be adjusted easily through the use of the handle 20 even during the cooking process.

The present invention advantageously provides essentially three modes of adjustment for the outdoor cooking assembly 10 that includes the rotatable adjustment of the stake assembly, the vertical adjustment of the grill 42, and the angler adjustment of the grill 42. This dynamic means of adjustment therefore enables the user to have the ability to vertically elevate and horizontally swing the grill as desired during the cooking process. The vertical adjustment of the grill is enabled through both the stake assembly and the rotation of the handle 20. Also the handle 20 and threaded screw assembly enables the angler adjustment of the grill. Such a dynamic mechanism therefore simplifies the use of the outdoor grilling assembly 10 and clearly surpasses the prior art in terms of maneuverability.

The outdoor grilling assembly 10 provides users with a comfortable and easy to use means of grilling that cannot be accomplished with the grilling assemblies presently known. Especially useful is the control handle 20 which may be maneuvered during the cooking process and therefore alleviates problems that may be associated with movement of the grill 42. Further, the grill 42 may be easily rotated horizontally through the rotation of the rotating outer sleeve 30, which does not come in contact with the heat associated with the cooking process. The outdoor grilling assembly 10 according to present invention therefore provides innovative and unique maneuvering mechanisms that greatly enhance the outdoor cooking experience for the user thereof.

What is claimed is:

1. An outdoor grilling assembly for open firing cooking comprising:
a. a vertical stake assembly, where said vertical stake assembly includes a rotating outer sleeve, a tension collar, a tension bolt, and an anchor pipe;
b. an arm extension attached to the top end of the rotating outer sleeve via a channel iron;
c. a threaded screw extending through an opening of the channel iron;
d. a handle, where said handle is attached to the top end of the threaded screw; and
e. a grill, said grill includes a channel/angle iron where said channel/angle iron provides a means to connect the grill to the distal end of the threaded screw and arm extension assembly.

2. The outdoor grilling assembly according to claim 1, where the rotating outer sleeve extends over the anchor pipe, where the tension collar and tension bolt provide a means to adjust the outer sleeve.

3. The outdoor grilling assembly according to claim 1, where the anchor pipe is driven into the ground to provide a stable means to support the outdoor grilling assembly.

4. The outdoor grilling assembly according to claim 2, where the tensioning collar may be positioned vertically along the anchor pipe and tensions the rotating outer sleeve into a suitable vertical position along the anchor pipe.

5. The outdoor grilling assembly according to claim 2, where the outer sleeve is rotated to provide a horizontal adjustment means for the grilling assembly.

6. The outdoor grilling assembly according to claim 1, where the tensioning collar is held into place with the tensioning bolt and provides a means to support the stake assembly.

7. The outdoor grilling assembly according to claim 1, further comprising an arm extension and a channel iron, where the arm extension and the channel iron are attached to a top end of the rotating outer sleeve, where the channel iron supports the arm extension and provides a means to support the cooking grill.

8. The outdoor grilling assembly according to claim 7, further comprising a threaded screw on a top end of the channel iron, where said threaded screw extends through the channel iron with a handle attached to the top end thereof and a channel/angle iron connection attaches to the opposite end of the threaded screw.

9. The outdoor grilling assembly according to claim 8, where a channel iron is provided near the midpoint of the arm extension and joins the arm extension to the threaded screw.

10. The outdoor grilling assembly according to claim 9, further comprising a clip pin nut that secures the connection of the channel iron to the threaded screw, wherein threads are provided within the clip pin nut to allow the free movement of the threaded screw.

11. The outdoor grilling assembly according to claim 10, where a user may maneuver the threaded screw by rotating the handle in either a clockwise or counter-clockwise direction to maneuver the angle and height of the cooking grill.

12. The outdoor grilling assembly according to claim 8, where channel angle iron connection includes an opening at a top end of the channel/angle iron connection for the insertion of the threaded screw, where the threaded screw maneuvers through this opening and adjusts through the use of the handle.
